(19) United States
(12) Patent Application Publication
(10) Pub. No.: US 2012/0101839 A1
(43) Pub. Date: Apr. 26, 2012

(54) System for and method of interaction of a pharmaceutical entity and its clients

(76) Inventor: Oleg Aronov, Rego Park, NY (US)

(21) Appl. No.: 12/925,563

(22) Filed: Oct. 26, 2010

(51) Int. Cl. G06Q 50/00

(52) U.S. Cl. 705/2

(57) ABSTRACT

A system and a method of interaction of a pharmaceutical entity with its clients has a pharmaceutical entity, a first cellular telephone provided at the pharmaceutical entity, a plurality of clients of the pharmaceutical entity, a plurality of further cellular telephones each provided at a respective one of the clients of the pharmaceutical entity, wherein the first cellular telephone at the pharmaceutical entity includes a telephone numbers of all the further cellular telephones of the clients, wherein each of the cellular telephones of each of the clients includes a cellular telephone number of the pharmaceutical entity, so that the pharmaceutical entity can reach any of the clients from the first cellular telephone dialing a respective one of the further cellular telephones of a respective one of the clients, and each of the clients can reach the pharmaceutical entity by dialing from the further cellular telephone of a respective one of the clients to the first cellular telephone of the pharmaceutical entity.

### BACKGROUND OF THE INVENTION

The present invention relates to a system and a method of interaction between a pharmaceutical entity and its clients.

It is known that clients of a pharmacy or a pharmaceutical entity place orders for medications based on corresponding prescriptions and receive medications from the pharmacy of the pharmaceutical entity directly, by visiting the pharmacy, by delivery of medications to their homes, etc.

It is believed that the existing systems and methods of interaction between the pharmaceutical entity and the clients can be further improved to increase their efficiency, to prevent unauthorized person's interference, etc.

### SUMMARY OF THE INVENTION

It is therefore an object of the present invention to provide a system for and method of interaction of a pharmaceutical entity which is a further improvement of the existing systems and methods.

In keeping with these objects one feature of the present invention resides in a system of interaction of pharmaceutical entity with its client which include a pharmaceutical entity; a first cellular telephone provided at the pharmaceutical entity; a plurality of clients of the pharmaceutical entity; a plurality of further cellular telephones each provided at a respective one of the clients of the pharmaceutical entity, wherein said first cellular telephone at the pharmaceutical entity includes a telephone numbers of all said further cellular telephones of the clients, wherein each of said cellular telephones of each of said clients includes a cellular telephone number of said pharmaceutical entity, so that the pharmaceutical entity can reach any of said clients from said first cellular telephone dialing a respective one of said further cellular telephones of a respective one of said clients, and each of said clients can reach the pharmaceutical entity by dialing from said further cellular telephone of a respective one of said clients to said first cellular telephone of said pharmaceutical entity.

A further feature of the present invention resides in the system, wherein said first cellular telephone and said further cellular telephones are in communication with one another so that the pharmaceutical entity via cellular telephone communication can ask the clients whether they are taking medications, how they feel after taking medications, whether they need refills, whether they want the refills to be delivered to them, whether they need a new prescription.

A further feature of the present invention resides in the system wherein said first cellular telephone and said further cellular telephones are in communication with one another so that the clients can tell the pharmaceutical entity whether they are taking medications, how they feel after taking medications, whether they need refills, whether they want the refills to be delivered to them, whether they need a new prescription.

Still a further feature of the present invention resides in the system, wherein said cellular telephones of said clients are cellular telephones which are purchased by said pharmaceutical entity, and services of said cellular telephones of said clients are services which are paid by said pharmaceutical entity.

In accordance with the present invention also a method of interaction between a pharmaceutical entity and its clients is proposed, comprising providing a plurality of clients of the pharmaceutical entity; providing a first cellular telephone at the pharmaceutical entity; providing a plurality of clients of the pharmaceutical entity; providing a plurality of each provided at a respective one of the clients of the pharmaceutical entity, including said first cellular telephone at the pharmaceutical entity includes a telephone numbers of all said further cellular telephones of the clients, wherein each of said cellular telephones of each of said clients includes a cellular telephone of said pharmaceutical entity, so that the pharmaceutical entity can reach any of said clients from said first cellular telephone dialing a respective one of said further cellular telephones of a respective one of said clients, and each of said clients can reach the pharmaceutical entity by dialing from said further cellular telephone of a respective one of said clients to said first cellular telephone of said pharmaceutical entity.

In accordance with a further feature the method is proposed communicating said first cellular telephone and said further cellular telephones with one another so that the pharmaceutical entity via cellular telephone communication can ask the clients whether they are taking medications, how they feel after taking medications, whether they need refills, whether they want the refills to be delivered to them, whether they need a new prescription.

In accordance with a further feature the method is proposed comprising communicating said first cellular telephone and said further cellular telephones with one another so that the clients call tell the pharmaceutical entity whether they are taking medications, how they feel after taking medications, whether they need refills, whether they want the refills to be delivered to them, whether they need a new prescription.

In accordance with a further feature of the present invention the method is proposed comprising purchasing said further cellular telephones of said clients by said pharmaceutical entity, and paying for services of said cellular telephones of said clients by said pharmaceutical entity.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a system of and a method for interaction between a pharmaceutical entity and its clients; in accordance with the present invention.

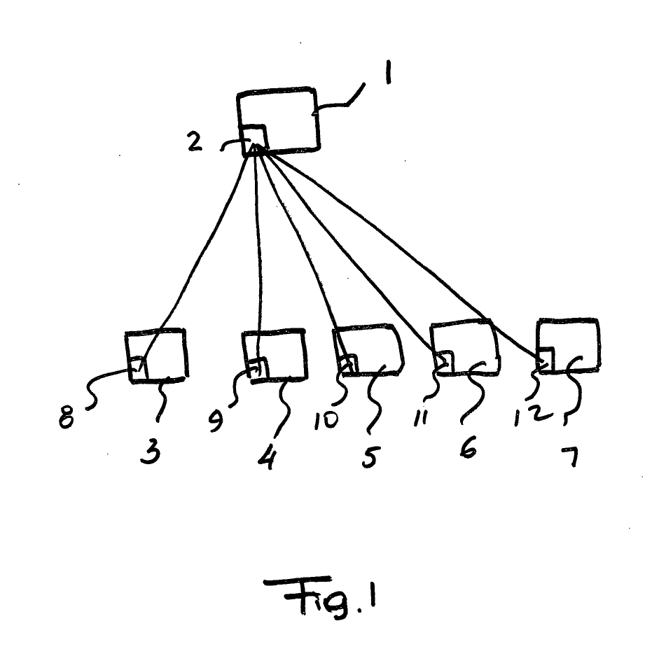

### DESCRIPTION OF THE PREFERRED EMBODIMENTS

In accordance with a present invention a system for interaction between a pharmaceutical entity and its clients is provided.

As shown in the drawings a pharmaceutical entity, which for example, can be a pharmacy is identified with reference numeral 1. The pharmaceutical entity 1 has a cellular telephone which is identified with reference numeral 2.

The pharmaceutical entity interacts with a plurality of clients identified with reference numerals 3, 4, 5, 6, 7. Each of the clients 3, 4, 5, 6, 7 have a further cellular telephone identified with reference numerals 8, 9, 10, 11, 12.

In accordance with the present invention the cellular telephone 2 of the pharmaceutical entity 1 has telephone numbers of the cellular telephones 8, 9, 10, 11, 12 of the clients 2, 4, 5, 6, 7 and vice versa.

In accordance with another feature of the present invention, the pharmaceutical entity 1 obtains or purchases from a cellular telephone service provider the cellular telephones and gives them to the clients, also pays for the services of the cellular telephones 8, 9, 10, 11, 12. This encourages the clients 2, 4, 5, 6, 7, to maintain the communication with the pharmaceutical entity, and additionally guarantee that no unauthorized entity can interact with the clients 2, 4, 5, 6, 7 thus disrupting the communication between the pharmaceutical entity 1 and the clients.

In accordance with the invention the first cellular telephone 2 and said further cellular telephones 8, 9, 10, 11, 12 are in communication with one another so that the pharmaceutical entity via cellular telephone communication can ask the clients 2, 3, 4, 5, 6, 7 whether they are taking medications, how they feel after taking medications, whether they need refills, whether they want the refills to be delivered to them, whether they need a new prescription.

In accordance with the invention the first cellular telephone 2 and said further cellular telephones 8, 9, 10, 11, 12 are in communication with one another so that the clients 3, 4, 5, 6, 7 call tell the pharmaceutical entity 1 whether they are taking medications, how they feel after taking medications, whether they need refills, whether they want the refills to be delivered to them, whether they need a new prescription.

It will be understood that each of the elements described above, or two or more together, may also find a useful application in other types of methods and constructions differing from the type described above.

While the invention has been illustrated and described as embodied in a system for and method of interaction of a pharmaceutical entity, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system of interaction of a pharmaceutical entity with its clients, comprising a pharmaceutical entity; a first cellular telephone provided at the pharmaceutical entity; a plurality of clients of the pharmaceutical entity; a plurality of further cellular telephones each provided at a respective one of the clients of the pharmaceutical entity, wherein said first cellular telephone at the pharmaceutical entity includes a telephone numbers of all said further cellular telephones of the clients, wherein each of said cellular telephones of each of said clients includes a cellular telephone number of said pharmaceutical entity, so that the pharmaceutical entity can reach any of said clients from said first cellular telephone dialing a respective one of said further cellular telephones of a respective one of said clients, and each of said clients can reach the pharmaceutical entity by dialing from said further cellular telephone of a respective one of said clients to said first cellular telephone of said pharmaceutical entity.

2. A system as defined in claim 1, wherein said first cellular telephone and said further cellular telephones are in communication with one another so that the pharmaceutical entity via cellular telephone communication can ask the clients whether they are taking medications, how they feel after taking medications, whether they need refills, whether they want the refills to be delivered to them, whether they need a new prescription.

3. A system as defined in claim 1, wherein said first cellular telephone and said further cellular telephones are in communication with one another so that the clients can tell the pharmaceutical entity whether they are taking medications, how they feel after taking medications, whether they need refills, whether they want the refills to be delivered to them, whether they need a new prescription.

4. A system as defined in claim 1, wherein said cellular telephones of said clients are cellular telephones which are purchased by said pharmaceutical entity, and services of said cellular telephones of said clients are services which are paid by said pharmaceutical entity.

5. A method of interact of a pharmaceutical entity with its clients, comprising, providing a plurality of clients of the pharmaceutical entity; providing a first cellular telephone at the pharmaceutical entity; providing a plurality of clients of the pharmaceutical entity; providing a plurality of each provided at a respective one of the clients of the pharmaceutical entity, including said first cellular telephone at the pharmaceutical entity includes a telephone numbers of all said further cellular telephones of the clients, wherein each of said cellular telephones of each of said clients includes a cellular telephone of said pharmaceutical entity, so that the pharmaceutical entity can reach any of said clients from said first cellular telephone dialing a respective one of said further cellular telephones of a respective one of said clients, and each of said clients can reach the pharmaceutical entity by dialing from said further cellular telephone of a respective one of said clients to said first cellular telephone of said pharmaceutical entity.

6. A method as defined in claim 5, further comprising communicating said first cellular telephone and said further cellular telephones with one another so that the pharmaceutical entity via cellular telephone communication can ask the clients whether they are taking medications, how they feel after taking medications, whether they need refills, whether they want the refills to be delivered to them, whether they need a new prescription.

7. A method as defined in claim 1, further comprising communicating said first cellular telephone and said further cellular telephones with one another so that the clients call tell the pharmaceutical entity whether they are taking medications, how they feel after taking medications, whether they need refills, whether they want the refills to be delivered to them, whether they need a new prescription.

8. A method as defined in claim 7, further comprising purchasing said further cellular telephones of said clients by said pharmaceutical entity, and paying for services of said cellular telephones of said clients by said pharmaceutical entity.
